(19) United States
(12) Patent Application Publication
(10) Pub. No.: US 2026/0322305 A1
(43) Pub. Date: Oct. 15, 2026

(54) Motor-Alternator Power Conversion System

(71) Applicant: Revolution Electric Motor Company, Inc., Reno, NV (US)

(72) Inventors: Timothy S. Rodgers, Bainbridge Island, WA (US); Christopher W. Gabrys, Reno, NV (US)

(21) Appl. No.: 19/549,156

(22) Filed: Feb. 25, 2026

Related U.S. Application Data
(60) Provisional application No. 63/940,581, filed on Dec. 14, 2025.
(60) Provisional application No. 63/873,875, filed on Sep. 1, 2025.
(60) Provisional application No. 63/768,141, filed on Mar. 6, 2025.

(51) Int. Cl. H02P 27/08; H02J 7/14; H02P 6/15; H02P 6/28

(52) U.S. Cl. CPC H02P 27/08; H02J 7/1484; H02J 7/1492; H02P 6/15; H02P 6/28; H02J 2207/20

(57) ABSTRACT

A motor–alternator power conversion system is disclosed. The system includes a bidirectional DC-DC power converter coupled between an electrical energy source and a DC link, and a commutation inverter coupled between the DC link and an electric machine. The bidirectional DC-DC converter regulates power flow between the electrical energy source and the electric machine and is controlled to operate with zero-voltage switching in both motoring and generating modes. The commutation inverter operates as an electronic commutator and supplies phase currents to the electric machine without high-frequency pulse-width modulation. A controller coordinates operation of the bidirectional DC-DC converter and the commutation inverter to support motoring, generating, and regenerative braking operation. In certain operating modes, the commutation inverter may be disabled while controlled power flow is maintained through the bidirectional DC-DC converter. The disclosed architecture separates high-frequency regulation from commutation, enabling efficient bidirectional operation of the electric machine.

This invention pertains to power conversion systems for synchronous electric machines, and more particularly to a motor-alternator power system in which a battery or other DC source is coupled to an electric motor-alternator through a high-frequency drive. The system is suited for applications including electric vehicles, hybrid vehicles, construction and mining equipment, and other mobile platforms that utilize regenerative power flow. The power conversion system enables very high-frequency switching operation from hundreds of kilohertz into the megahertz range while preserving zero-voltage switching (ZVS) in both motoring and generating modes, and is capable of scaling from tens of kilowatts to megawatt-class power levels.

### BACKGROUND OF THE INVENTION

There is much effort presently being undertaken to develop new electric and hybrid electric vehicles and equipment in interests to save energy and operating costs. Significant development is also being undertaken to reduce weight and increase power conversion efficiency. Air core motor-alternators are being developed for these applications because they can provide very high power densities, low mass, and reduced manufacturing complexity and costs compared to conventional electric machines. A characteristic of air core machines, however, is that their armature windings exhibit substantially lower inductance.

When driven at conventional pulse-width-modulated (PWM) switching frequencies, the low winding inductance produces large current ripple, increased copper losses, and reduces overall efficiency. Likewise, when operating as an alternator and boosting voltage from low-inductance windings using standard PWM methods, similar ripple, loss, and efficiency issues occur. Increasing switching frequency in an effort to reduce current ripple introduces substantial switching losses, device stresses, and electromagnetic interference (EMI). High dv/dt transitions associated with all PWM motor drives also generate significant common-mode voltage, which can impose damaging shaft voltages and induce bearing currents that reduce machine life. These challenges become even more severe when scaled to higher power levels. Although additional series inductance may be inserted between the power converter and the motor-alternator to moderate these effects at conventional switching frequencies, the added size, weight, cost, and losses make this an unacceptable solution for many applications.

Accordingly, a new motor-alternator power conversion system is needed that can operate effectively with low-inductance air core electrical machines, including high-performance variants. Such a system would preclude the generation of high conversion losses, EMI, damaging shaft voltages, and bearing currents while providing power-regulation switching at higher frequencies. It would further have long operating life with low device stresses and utilize minimized-cost construction.

### SUMMARY OF THE INVENTION

The present invention provides a new motor-alternator power conversion system that solves the limitations described in the Background. In particular, the invention enables efficient motoring and generating operation with low-inductance air core electric machines, while avoiding the high switching losses, dv/dt stress, EMI generation, and bearing-current excitation associated with PWM motor drives. The disclosed power conversion system shifts high-frequency switching to a bidirectional half-bridge buck-boost stage operating from hundreds of kilohertz into the megahertz range while maintaining zero-voltage switching (ZVS) in both directions of power flow. This architecture provides compact, lightweight, and highly efficient power conversion suitable for electric vehicles, hybrid vehicles, construction and mining equipment, and other mobile applications requiring regenerative power flow. Unlike prior art motor drives, the disclosed architecture decouples phase commutation from torque regulation while preserving bidirectional energy flow and soft-switching (including near-zero-voltage turn-on), across current reversal boundaries. Conventional traction architectures teach regulating phase current with inverter PWM, and would not be expected to maintain stable, low-ripple torque control in low-inductance machines if inverter PWM is removed and replaced by a separate high-frequency bidirectional converter operating across motoring–generating current reversals.

In one embodiment, a motor-alternator power conversion system includes a battery, a commutation output inverter, and a non-isolated, bidirectional half-bridge buck-boost converter interposed between the battery and a DC link supplying the inverter. The commutation inverter is coupled to the phase windings of a synchronous electric machine, and each inverter switch provides a reverse-conduction path through either an anti-parallel diode or channel conduction of a wide-bandgap transistor. The buck-boost stage includes a high-side switch, a low-side switch, an inductor, and a link capacitor.

The controller regulates current through the bidirectional half-bridge buck-boost converter to establish motor torque in a motoring mode and to draw regenerative power from the electric machine in a generating mode. During generating operation, the controller actively regulates current through the bidirectional half-bridge buck-boost converter, causing regenerative current to flow through the inverter switches of the commutation output inverter, including via reverse-conduction paths and/or actively gated channel conduction, into the DC link and to the battery. Unexpectedly, both the high-side and low-side switches of the half-bridge achieve zero-voltage switching across a broad operating range, even though the converter uses only two active switches and no auxiliary resonant networks. In particular, the disclosed ZVS behavior is maintained while the commutation inverter is intentionally operated without high-frequency PWM, such that the DC-DC stage must supply rapid bidirectional current regulation to satisfy machine torque dynamics without the inverter providing ripple cancellation. In many cases, this ZVS behavior persists under rapid torque transitions and load disturbances, demonstrating an unusually wide robustness margin for a two-switch bidirectional architecture. This division of functions allows the commutation inverter to operate without high-frequency modulation while the bidirectional converter establishes torque and braking response. This arrangement departs from conventional PWM motor drives, which regulate phase current using inverter PWM and substantially reduces motor-terminal dv/dt and associated EMI mechanisms.

In a further embodiment, the controller maintains soft switching without requiring auxiliary resonant tanks, snubbers, clamp circuits, or multilevel switching arrangements. Soft switching is preserved by enforcing the condition I_{L} × t_{dead} ≥ Qₒₛₛ × V_{bus} for at least a majority of switching cycles. This relationship ensures that the inductor current during dead time is sufficient to resonantly charge and discharge switch-node capacitances, allowing each switch to turn on at or near zero voltage. Unlike fixed dead-time tuning used in many converters, the disclosed control maintains the resonant energy condition through torque transients and current sign reversals that occur during transitions between motoring and generating operation. This enables higher switching frequencies than previously achievable without incurring prohibitive switching loss or device stress.

In yet another embodiment, the controller includes adaptive dead-time control. Dead-time adjustment may be based on body-diode conduction intervals, switch-node slope, sensed valley-timing events, or other observed behavior that indicates the energy available for resonant transitions. This adaptive timing maintains high-frequency soft switching under varying load, bus voltage, temperature, and motor operating conditions. Such adaptive behavior compensates for wide variations in winding inductance, DC-link voltage ripple, and battery impedance that would otherwise disrupt ZVS.

In another embodiment, the control system enforces a minimum circulating-current bias in the half-bridge during at least one of the motoring or generating modes. This circulating current ensures that sufficient resonant energy exists for soft-switching transitions,including near-zero-voltage turn-on, during periods of light load, current polarity reversal, or when motor electrical frequency does not provide adequate back-emf support. As a result, soft switching is maintained even when instantaneous torque demand is extremely low, which is typically the operating region where conventional converters lose ZVS first. The circulating current may be substantially smaller than rated motor current, allowing soft switching to be maintained without materially affecting machine efficiency. This provides a controllable ZVS margin across load transients and current sign reversals. It has been found that further efficiency improvements may be realized at very light loads. In one embodiment, the controller performs valley or near-valley turn-on when said inductor current is insufficient for full zero-voltage transition. Valley-detection techniques reduce turn-on loss, suppress switching-voltage overshoot, and maintain stable operation near zero-torque boundaries. This enables the converter to remain stable and efficient even when operating near discontinuous-conduction boundaries where conventional buck-boost converters may become noisy and erratic . This combination of controlled circulating current and valley-timed transitions allows the converter to avoid entering chaotic or burst-mode behavior, providing smoother dynamic response and reducing acoustic noise during low-power operation.

In some implementations, the direction of power flow is determined using information such as a torque-request sign, a mechanical power sign, a DC-link power sign, a relationship between back electromotive force and DC-link voltage, or a polarity and/or magnitude of current through the inverter switches of the commutation output inverter. The controller may apply hysteresis or temporal filtering to these parameters to avoid chatter at the motoring–generating boundary. This produces smooth transitions between torque production and regenerative braking. Using multiple indicators also provides redundancy that improves control reliability under noisy or rapidly changing operating conditions. These redundant indicators further allow graceful degradation, enabling the system to maintain correct power-flow classification even when one or more sensors exhibit transient error or reduced accuracy. By avoiding reliance on a single indicator, the system prevents incorrect mode classification that could otherwise induce current discontinuities or loss of regenerative control.

In another embodiment, the output inverter is operated as a hard-switched, non-modulating commutator while torque is regulated solely by the half-bridge current. By eliminating high-frequency PWM from the commutation inverter, the system dramatically reduces dv/dt across motor terminals, lowers common-mode voltage, suppresses bearing-current formation, and mitigates EMI emission. These advantages are particularly beneficial when driving low-inductance air core machines whose phase currents would otherwise experience excessive ripple under conventional PWM regulation. For example, with a plurality of interleaved converter legs (e.g., twelve legs) each switching at 100 kHz, the effective ripple frequency at the DC link is increased (e.g., to approximately 1.2 MHz). In contrast to conventional six-step BLDC drives that rely on inverter PWM for current shaping, the disclosed architecture achieves traction-class torque control using converter-regulated DC-link current while the inverter performs commutation only. This approach effectively converts the commutation inverter into a high-current electronic commutator that preserves motor life while reducing system-level filtering requirements.

In a related embodiment, the inductor and link capacitor of the buck-boost stage are sized to limit ripple current into the electric machine and to provide sufficient dynamic response to track the machine’s sinusoidal back electromotive force. The resulting phase currents supplied by the commutation inverter are substantially flat-topped, reducing copper loss and improving torque production efficiency in low-inductance winding configurations. Such flat-topped currents are counter to conventional PWM control, which typically produces high ripple in low-inductance machines.

In another embodiment, the active switches of the half-bridge comprise wide-bandgap transistors such as GaN or SiC devices. Devices are selected to exhibit sufficiently low output charge Qₒₛₛ such that switching frequencies in the hundreds of kilohertz to the megahertz range can be achieved with overall system efficiencies approaching or exceeding 98 percent in some implementations. This represents a significant advance in high-power motor drive systems, where MHz-class switching has traditionally been unattainable due to prohibitive switching loss. This combination of wide-bandgap devices with the disclosed ZVS conditions allows power densities substantially higher than achievable with conventional silicon-based motor drives.

In one non-limiting example implementation, the disclosed motor–alternator power conversion system was realized at a power level of 230-250 kilowatts using a twelve-phase interleaved bidirectional half-bridge buck-boost converter. Each converter leg operated at a switching frequency of 100 kilohertz, such that the effective regulation frequency presented to the DC link and commutation inverter was approximately 1.2 megahertz. In this implementation, zero-voltage switching of the half-bridge switches was maintained in both motoring and generating operation while the commutation output inverter operated without high-frequency pulse-width modulation. Overall system efficiency exceeded 98 percent over a substantial portion of the operating range, demonstrating that the disclosed architecture scales to high power levels while preserving soft-switching behavior, low electrical stress, and stable bidirectional operation.

During generating operation, the controller may optionally disable synchronous conduction of the commutation output inverter. When synchronous conduction is disabled, the reverse-conduction paths of the inverter switches act as a passive rectification means for delivering regenerative current into the DC link. This simplifies regenerative operation, reduces inverter switching activity, and increases robustness under faulted or low-power conditions.

Smooth transitions between motoring and generating may be achieved by gradually ramping the commanded current through zero while maintaining bounded DC-link conditions under current regulation. The controller preserves soft-switching during this transition by monitoring inductor current, back emf, and DC-link behavior. This provides smooth transitions without torque disturbances.

In another embodiment, a method for operating a motor-alternator power conversion system includes supplying motoring torque by regulating current through the half-bridge converter into the DC link while the commutation inverter commutates the phase windings of the synchronous electric machine. During generating operation, regenerative power is received by current-regulating the bidirectional half-bridge buck-boost converter to draw power from the electric machine into the DC link and to the battery while current flows through the inverter switches of the commutation output inverter, including via reverse-conduction paths and/or actively gated channel conduction. The half-bridge is pulse-width modulated with controlled dead-time such that, in both motoring and generating operation, each switch turns on at or near zero voltage by using inductor current during the dead time to resonantly transfer charge between switch-node capacitances.

In a further embodiment, the dead time used during switching of the half-bridge converter is adaptively adjusted based on observed switch-node behavior. The controller may detect body-diode conduction intervals, monitor the slope of the switch-node voltage, or evaluate the timing of resonant valleys to determine whether sufficient energy exists for zero-voltage transitions. By adjusting dead time to satisfy the condition I_{L} × t_{dead} ≥ Qₒₛₛ × V_{bus}, soft switching is preserved across a broad range of load and operating conditions.

In another embodiment, the method enforces a minimum inductor-current floor near light-load and transition boundaries. Maintaining a small circulating current ensures that resonant charge transfer continues to support near-zero-voltage switching, even when torque demand or regenerative power is near zero. This circulating current can be selected low enough that it does not impart measurable torque to the machine while still preserving efficient soft switching.

Additional benefits may be achieved under light-load conditions by performing valley or variable-frequency operation when inductor current is insufficient for full resonant transition. In one embodiment, the controller monitors switch-node behavior and executes a valley-timed gate command to reduce turn-on losses, suppress switching-voltage overshoot, and maintain high efficiency during low-power operation. These techniques extend soft-switching behavior to load regions where it is typically lost in conventional half-bridge converters. By retaining predictable switching behavior in this region, the method avoids subharmonic oscillations and cycle-skipping effects that typically complicate control during low-power operation.

In some embodiments, the direction of power flow in the method is determined from indicators including the sign of torque request, mechanical power sign, DC-link power measurement, the relationship between back electromotive force and DC-link voltage, or the polarity of current through the commutation output inverter. Hysteresis may be incorporated into this decision to avoid chatter between motoring and generating modes and to stabilize control boundaries. This produces smooth transitions in operating mode while maintaining stable converter operation under current regulation and bounded DC-link behavior

The method may also incorporate battery-chemistry-specific charging limits including constant-current regulation, constant-voltage regulation, or temperature-based derating. These constraints ensure safe regenerative charging while maintaining soft-switching behavior in the converter and stable current flow from the electric machine.

In one embodiment, a controller for a motor–alternator system generates pulse-width modulation signals for a bidirectional half-bridge buck-boost converter that couples a battery and a commutation output inverter. The controller regulates current flowing between the battery and a DC link by pulse-width modulation of the bidirectional half-bridge buck-boost converter, wherein the magnitude and direction of the regulated current determine motor torque during motoring operation and regenerative braking torque during generating operation. The controller generates gate signals for the commutation output inverter to commutate the phase windings based on rotor position information without high-frequency pulse-width modulation, such that the commutation output inverter does not regulate phase current magnitude. Transition between motoring and generating is achieved by reversing the sign of the regulated current while maintaining substantially unchanged commutation timing. Dead-time intervals are inserted such that each switch of the half-bridge turns on at or near zero voltage by utilizing inductor current during dead time to resonantly transfer charge between switch-node capacitances. This control strategy enables vehicle acceleration, deceleration, and reversal to be governed primarily by converter current control rather than inverter modulation.

In a related embodiment, the control circuitry includes adaptive dead-time adjustment. The controller may detect the onset of diode conduction, changes in switch-node slope, or shifts in resonant timing to determine whether additional dead time or reduced dead time will maintain soft-switching conditions. These adjustments compensate for variations in device parameters, temperature, and motor operating point.

In another embodiment, the controller maintains a minimum circulating current in the bidirectional half-bridge converter during light-load operation. This circulating current preserves resonant conditions sufficient for soft switching while being coordinated with motor back electromotive force so that it does not impart measurable torque to the phase windings. The result is improved soft-switching reliability at load levels where conventional converters revert to hard switching.

The controller may also determine power-flow direction from torque-request polarity, DC-link power sign, or reverse-conduction polarity through the commutation inverter. In certain embodiments, the controller applies hysteresis or temporal filtering to avoid rapid mode toggling and to maintain stable operation near torque-zero boundaries. This produces predictable transitions between motoring and regenerative operation.

A further embodiment provides that the commutation output inverter operates without high-frequency pulse-width modulation, relying instead on the half-bridge converter for regulation. By eliminating PWM from the inverter, common-mode voltage is reduced, bearing-current excitation is suppressed, and dv/dt stress on the machine windings is minimized. This configuration is particularly effective for low-inductance air core machines.

In some embodiments, the control circuitry applies commutation overlap between phase conduction intervals of the commutation output inverter to reduce current discontinuities associated with commutation events. In some implementations, without the addition of commutation overlap, phase currents during motoring can sometimes encounter appreciable current spikes or peaks at commutations at certain speed and load conditions. These non-flat current tops are attenuated with the application of commutation overlap.

In a further embodiment, the control circuitry limits a rate of change of regulated current commanded through the bidirectional half-bridge buck-boost converter during transitions between motoring and generating operation to reduce mechanical excitation and electrical stress.

In the same motor-alternator power conversion architecture described above, a fault-tolerant operating mode is provided. In yet another embodiment, a motor-alternator power conversion system includes a battery, a synchronous electric machine, a commutation output inverter, and a non-isolated bidirectional half-bridge buck-boost converter. Upon detection of a loss, disablement, or fault condition associated with gate-drive control of the commutation output inverter, the controller disables active gating of the inverter switches. The inverter thereby enters a passive conduction state in which current may flow only through the reverse-conduction paths of the inverter switches. This mode provides controlled regenerative braking even when inverter gate-drive control is unavailable and passive rectification alone would be ineffective due to insufficient back-emf at low speed. During this passive conduction state, the controller actively regulates current through the bidirectional half-bridge buck-boost converter to control regenerative braking torque applied by the synchronous electric machine. Unlike conventional drives, regenerative braking torque is not determined solely by rectified back electromotive force of the machine, but is instead governed by controlled current drawn through the converter. This allows controlled regenerative braking to be maintained even when the machine back-emf is insufficient to overcome battery voltage through passive rectification alone. With the bidirectional converter remaining actively gated during the passive conduction state, the system regulates braking torque by controlling converter current even when the rectified machine voltage would otherwise be clamped below battery voltage. Conventional inverter-only drives lose controllable braking torque under such fault conditions once rectified back-emf falls below battery voltage.

In a related embodiment, the bidirectional half-bridge buck-boost converter is operated to boost rectified machine voltage during the passive conduction state, thereby enabling regenerative current to be transferred to the battery when the DC-link voltage is less than the battery voltage. This extends regenerative braking capability to lower machine speeds and operating points where conventional diode-rectified regeneration would otherwise cease.

In some embodiments, controlled regenerative braking is maintained over a speed range extending below a speed at which passive rectification through the inverter switches alone would no longer deliver power to the battery. This provides braking capability at low speeds and during downhill or deceleration events where conventional inverter-based regenerative braking systems lose effectiveness following inverter disablement.

In another embodiment, regenerative braking torque during the passive conduction state is determined primarily by regulated converter current rather than by rectified machine voltage. By decoupling braking torque from instantaneous back-emf magnitude, the system achieves predictable and controllable braking response across a wide operating range.

In some embodiments, during the passive conduction state the controller regulates converter current as a function of available DC-link voltage and/or energy to avoid DC-link overvoltage while maintaining regenerative braking torque. This enables stable braking control without reliance on active inverter switching or machine flux-control mechanisms.

In still other embodiments, the loss, disablement, or fault condition triggering the passive conduction state comprises at least one of a gate-driver fault indication, loss of gate-drive supply voltage, or a commanded torque-inhibit condition. The system thereby provides a fail-operational regenerative braking mode that remains available even when conventional inverter-controlled braking is unavailable.

### DESCRIPTION OF THE DRAWINGS

The invention and its many advantages and features will become better understood upon reading the following detailed description of the preferred embodiments in conjunction with the following drawings, wherein:

FIG. 1 is a schematic diagram of a motor-alternator power conversion system in accordance with the invention.

FIG. 2 is a schematic diagram of an alternate configuration of a motor-alternator power conversion system in accordance with the invention, illustrating a multi-leg, interleaved bidirectional half-bridge buck-boost converter.

FIG. 3 is a schematic representation of an inverter-disabled regenerative-braking mode of a motor-alternator power conversion system of FIG. 1 in accordance with the invention.

FIG. 4 is a timing diagram illustrating zero-voltage-switching (ZVS) behavior of the bidirectional half-bridge of a motor-alternator power conversion system in accordance with the invention.

FIG. 5 is a block diagram of controller functional components with interconnections of a motor-alternator power conversion system in accordance with the invention.

FIG. 6 is a flow diagram illustrating a method of operating a motor-alternator power conversion system in accordance with the invention.

### DESCRIPTION OF THE PREFERRED EMBODIMENT

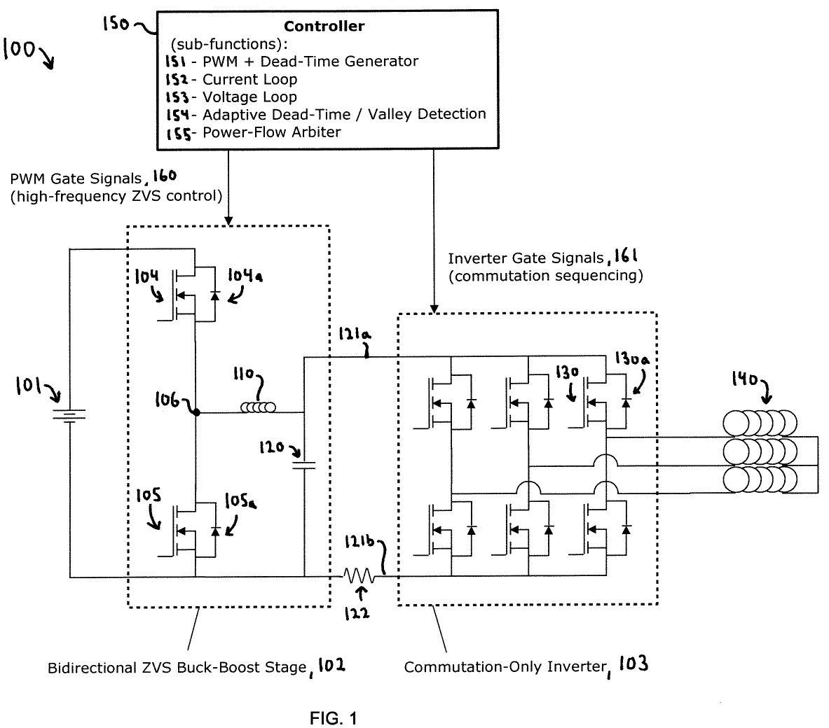

Turning to the drawings, wherein like reference characters designate identical or corresponding parts, a motor-alternator power conversion system in accordance with the invention is shown in FIG. 1. The power conversion system 100 comprises a battery 101 supplying a non-isolated, bidirectional half-bridge buck-boost converter 102. Converter 102 includes a high-side switch 104 and a low-side switch 105, which may be silicon or wide-bandgap MOSFETs or IGBTs, and which alternately conduct to regulate current flow. Each of switches 104 and 105 further includes a reverse conduction path, shown respectively as 104a and 105a, which may be implemented as an intrinsic body diode in a MOSFET or as channel conduction in the case of a GaN device. Switches 104 and 105 are joined at a common switch node 106. An inductor 110 is connected between switch node 106 and a DC link 121a, 121b, the DC link comprising a positive rail 121a and a negative rail 121b. A DC-link capacitor 120 is coupled across rails 121a and 121b to smooth voltage and confine switching ripple. A current-sense element 122 is positioned in series with negative rail 121b between converter 102 and the commutation output inverter 103.

Commutation inverter 103 is a three-phase bridge comprising multiple switching devices. By way of example, one such inverter device is designated as transistor 130, which is provided with a reverse conduction path 130a. Inverter 103 is coupled to motor/alternator windings 140 of a synchronous electric machine. At any instant, inverter 103 operates to commutate two of the phase windings 140 in series conduction, providing motoring torque or accepting generating current. Commutation inverter 103 switches substantially at the electrical frequency of the motor and does not perform high-frequency pulse-width modulation for torque or current regulation.

A controller 150 is operatively connected to switches 104, 105 of converter 102 and to inverter 103. Controller 150 includes functional sub-blocks, shown in FIG. 1 as: a PWM and dead-time generator 151, adaptive dead-time and valley detection logic 154, a current regulation loop 152 for motoring mode, a generating-mode regulation loop 153 configured to regulate battery charging, including current regulation and voltage limiting, a power-flow arbiter and hysteresis unit 155, and a battery-chemistry charging limits module. Controller 150further receives feedback from current-sense element 122, DC-link voltage across capacitor 120, and battery voltage from 101.

During motoring operation, controller 150, through current regulation loop 152, commands duty cycles to switches 104 and 105 such that current measured through shunt 122 is regulated to meet a torque-producing current command. Inverter 103 functions as a commutator, with devices such as 130 sequencing conduction of motor windings 140, while high-frequency regulation is confined to converter 102.

During generating operation, current conduction through the commutation output inverter 103 may be implemented via passive reverse-conduction paths 130a and/or via actively gated channel conduction of the inverter switches 130, without requiring high-frequency pulse-width modulation of the inverter 103. When actively gated channel conduction is enabled, the inverter switches 130 are gated synchronously with phase commutation timing to reduce conduction losses while remaining free of high-frequency pulse-width modulation. In certain embodiments, the controller 150 selectively enables or disables active gating of the inverter switches 130 during generating operation, such that regeneration may be carried out either by passive rectification through reverse-conduction paths 130a or by actively gated channel conduction, while maintaining substantially identical current regulation behavior.

As shown during generating operation, controller 150, through current regulation subject to battery voltage limits 153, maintains charging of battery 101. Regenerative current flows from windings 140 through inverter 103 and into DC link 121a, 121b, across shunt 122, and into converter 102. Converter 102, by alternating conduction of switches 104 and 105 with resonant dead-time transitions, transfers energy back to battery 101 at or near zero-voltage switching.

Because inverter 103 commutates at low frequency rather than high-frequency PWM, the common-mode voltage presented to motor windings 140 is minimal, suppressing bearing currents and electromagnetic interference. Converter 102 achieves near-lossless regulation by soft-switching both switches 104 and 105 in both directions of power flow.

### Detailed Switching Operation:

By way of example, in converter 102, the high-side MOSFET 104 and the low-side MOSFET 105 alternately conduct, with their reverse conduction paths 104a, 105a providing bidirectional current flow during dead-time intervals. Zero-voltage switching of the bidirectional half-bridge converter 102 is achieved independently of motor back electromotive force and does not rely on synchronous machine inductance or phase current polarity. In commutation inverter 103, one device such as transistor 130 controls current into a motor winding, with its reverse conduction path 130a conducting during intervals of opposite current polarity. Other inverter devices (not separately numbered) function analogously for the remaining phases.

### Motoring buck mode

When torque command from controller 150 requires current delivery from battery 101 to motor windings 140, MOSFET 104 is driven on and off under pulse-width modulation while 105 provides complementary conduction. During the dead-time after 104 turns off, inductor 110 current continues to flow through reverse conduction path 105a, discharging the output capacitance of 120 and charging that of 105. At the valley of the switch-node 106 waveform, controller 150 commands 105 to turn on at or near zero voltage. Subsequently, during the next transition, current again slews the node 106 so that 104 can be turned on under zero-voltage conditions. The regulated current through shunt 122 flows into commutation inverter 103, where switch 130 commutates phase current into motor winding 140. The resulting substantially flat-topped phase currents are a deliberate consequence of DC-link current regulation rather than a byproduct of filtering.

### Generating boost/charging mode

When the motor/alternator supplies regenerative power, current flows from windings 140 through inverter transistor 130 and its reverse conduction path 130a into DC link 121a, 121b. The current passes through shunt 122 and into converter 102, where controller 150 regulates battery 101 charging. During the dead-time following turn-off of low-side MOSFET 105, the inductor 110 current flows through reverse conduction path 104a, slewing the node voltage at 106 so that MOSFET 104 can be turned on at or near zero voltage. Subsequent turn-off of 104 allows current through 105a and then a zero-voltage turn-on of 105, maintaining ZVS in both devices while transferring energy back into battery 101. As used herein, ‘zero-voltage switching’ includes switching at or near zero voltage. Zero-voltage switching is preserved during phase commutation events and current polarity reversals imposed by the commutation inverter, including at high electrical frequencies.

### Light-Load and Transition Behavior

At low current, controller 150 employs adaptive dead-time logic 154 and may enforce a circulating current floor so that resonant commutation persists. If sensed current through 122 falls near the threshold defined by Qₒₛₛ x (V_{bus}) / t_{dead}, controller 150 selectively extends dead-time and/or executes valley or near-valley turn-on of switches 104, 105, optionally with limited frequency adjustment, to preserve resonant charge transfer. When power-flow direction reverses across zero, arbiter 155 ramps the commanded current through zero while keeping the DC link 121a, 121b stable, ensuring seamless changeover between motoring and generating without losing ZVS. The controller maintains operation substantially within continuous conduction or controlled boundary conduction and avoids uncontrolled discontinuous-conduction or burst-mode operation that would otherwise disrupt soft-switching behavior.

### The Controller Regulates Operation in Two Distinct Modes

In motoring, the controller 150 enforces current regulation, commanding the half-bridge duty cycle such that flat-topped motor currents are maintained even in the presence of sinusoidal back emf. In generating, the controller 150 enforces voltage regulation to charge the battery 101. Regenerative current flows naturally through the reverse conduction paths 130a of the inverter, enabling simple and robust energy recovery.

The controller 150 inserts controlled dead-times between switch transitions. During these intervals, inductor 110 current interacts with switch-node capacitances to resonantly commutate the node voltage 106. With properly sized inductance and capacitance, this ensures that each switch 104, 105 turns on at or near zero voltage in both directions of power flow. Adaptive dead-time adjustment, minimum circulating current bias, and valley-turn-on control further extend soft-switching operation to light-load regions.

In contrast to conventional systems where inverter transistors must modulate against sinusoidal back emf and thus switch with significant overlap of voltage and current, the present invention employs a half-bridge converter 102 that inherently transitions at or near zero voltage. This design choice eliminates the dominant source of switching loss in conventional motor drives and is a key factor enabling the efficiency and scalability advantages of the invention.

Because the commutation inverter 103 operates only as a sequencer of motor phases 140, and not as a high-frequency modulator, the motor terminals are largely immune from rapid dv/dt stress. The result is greatly reduced common-mode voltage and bearing current, mitigating a common failure mode of conventional inverter-driven machines. Furthermore, because the half-bridge transitions are resonant and soft, the system generates far less EMI than conventional drives, often reducing or eliminating the need for bulky external filters. These attributes yield a motor–alternator system of improved efficiency, reliability, and electromagnetic compatibility.

Controller 150 further determines power-flow direction based on at least one of: torque request sign, DC-link power sign, back emf relative to DC-link voltage, or reverse conduction polarity through the commutation inverter 130, and applies hysteresis and temporal filtering to such determinations in order to avoid chatter between motoring and generating modes.

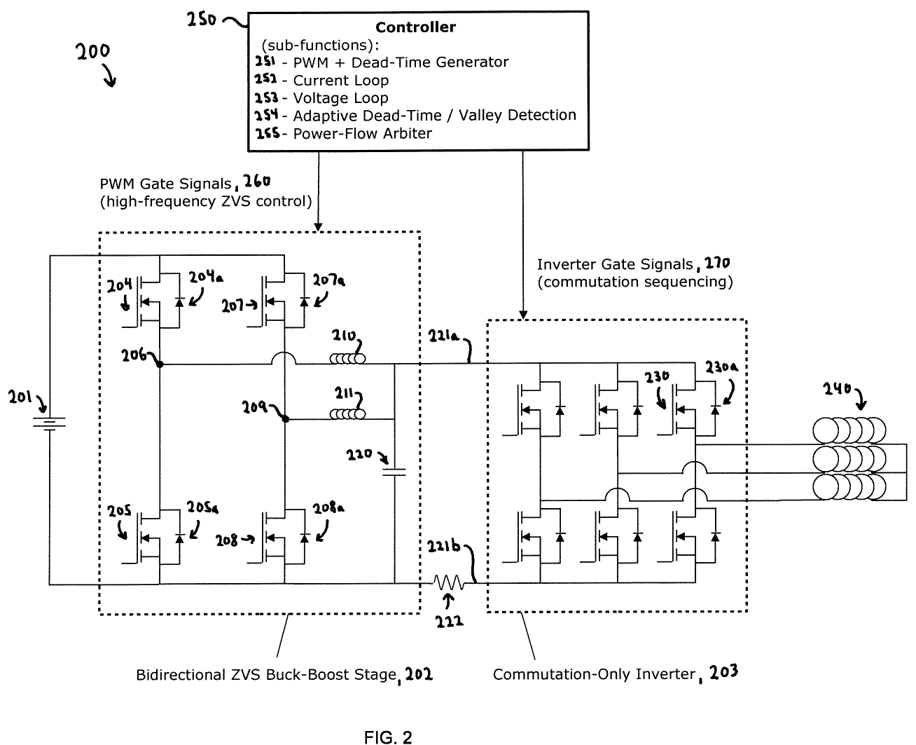

A schematic diagram of an alternate configuration of a motor-alternator power conversion system in accordance with the invention, illustrating a multi-leg, interleaved bidirectional half-bridge buck-boost converter is shown in FIG. 2. The power conversion system 200 comprises a battery 201 supplying a non-isolated, bidirectional half-bridge buck-boost converter 202. Converter 202 includes a high-side switch 204 and a low-side switch 205, which may be silicon or wide-bandgap MOSFETs or IGBTs, and which alternately conduct to regulate current flow. Each of switches 204 and 205 further includes a reverse conduction path, shown respectively as 204a and 205a. Switches 204 and 205 are joined at a common switch node 206. An inductor 210 is connected between switch node 206 and a DC link 221a, the DC link comprising a positive rail 221a and a negative rail 221b. Converter 202 also includes switches 207 and 208 and reverse conduction paths 207a and 207b which are interleaved with converter switches 204, 205 such that the pairs switch out of phase with each other. Switches 207 and 208 and joined at a common switch node 209 and inductor 211 couples the node 209 to the positive rail 221. A DC-link capacitor 220 is coupled across rails 221a and 221b to smooth voltage and confine switching ripple. A current-sense element 222 is positioned in series with negative rail 221b between converter 202 and the commutation output inverter 203. Paralleling and interleaving of transistor pairs 204, 205 and 207, 208, increases the current capacity of the converter 202 and the regulation switching frequency seen by the capacitor 220, inverter 203 and motor-alternator windings 240. With two pairs or phases 204, 205 and 207, 208, the regulation switching doubles. In larger higher power systems, 12 or more phases may be interleaved and for 12 phases with each switching at 100 kHz, the regulation switching frequency accordingly increases to 1.2 MHz. This dramatically reduces the required size of bus capacitance 220 as well as ripple into the motor-alternator windings.

### Example High-Power Interleaved Implementation

In one example implementation, the motor–alternator power conversion system 200 illustrated in FIG. 2 was configured as a high-power interleaved architecture rated at approximately 230–250 kilowatts. The bidirectional half-bridge buck-boost converter 202 comprised twelve parallel converter legs, each converter leg including a high-side switching device and a low-side switching device (for example, switches 204 and 205), with additional interleaved converter legs implemented similarly (for example, switches 207 and 208), and operated with interleaved switching phases. Each converter leg operated at a switching frequency of 100 kilohertz, such that the effective regulation frequency presented to the DC link 221a, 221b exceeded 1.2 megahertz.

The half-bridge converter 202 employed switching devices selected for low output charge Qoss, including wide-bandgap devices in certain implementations. Inductor values such as 210 and 211, dead-time intervals generated by a controller (for example, controller 250, described below), and current regulation parameters were selected such that, during a majority of switching cycles in both motoring and generating operation, the condition IL × tdead ≥ Qoss × Vbus was satisfied, where IL corresponds to current through inductors 210, 211 and Vbus corresponds to the DC-link voltage across rails 221a, 221b. As a result, zero-voltage switching of the active switches of converter 202 was consistently maintained without auxiliary resonant networks, clamp circuits, snubbers, or additional commutation components.

In this implementation, the commutation output inverter 203 operated as a non-modulating electronic commutator and did not employ high-frequency pulse-width modulation. Torque regulation during motoring operation and battery-charging regulation during generating operation were performed exclusively by the bidirectional half-bridge converter 202 under control of controller 250. Confining high-frequency switching to converter 202 substantially reduced dv/dt at the motor terminals 240, reduced common-mode voltage, and suppressed shaft-voltage and bearing-current excitation relative to inverter architectures that employ high-frequency PWM at the commutation stage.

The commutation output inverter 203 in this example implementation was realized using either wide-bandgap switching devices or silicon IGBT devices with antiparallel diodes. Because inverter 203 operated without high-frequency pulse-width modulation and switched primarily at motor electrical frequency, both device classes were suitable for use while maintaining high overall system efficiency. Selection of inverter device technology may be based on factors including efficiency targets, thermal constraints, availability, and production volume, without altering operation of the bidirectional half-bridge converter 202.

Interleaving of the converter legs of converter 202 reduced ripple current flowing into DC-link capacitor 220 and allowed the DC-link capacitance to be substantially reduced while maintaining stable regulation and soft-switching behavior. Concentrating regulation switching in the bidirectional half-bridge converter 202 further reduced electromagnetic interference and simplified system-level filtering requirements. The disclosed architecture enabled efficient operation with low-inductance synchronous electric machines, including air-core motor-alternators, while preserving stable current regulation, high efficiency, and robust operation during rapid torque transitions and regenerative braking events.

In this example implementation, overall system efficiency exceeded 98 percent across a substantial portion of the operating range. Stable zero-voltage switching of the converter 202 was maintained during power-flow reversals, rapid torque transients, and regenerative braking, demonstrating that the disclosed motor–alternator power conversion system scales to high power levels while retaining the soft-switching, low-stress, and low-EMI characteristics described herein.

Commutation inverter 203 is a three-phase bridge comprising multiple switching devices. One such inverter device is designated as transistor 230, which is provided with a reverse conduction path 230a. Inverter 203 is coupled to motor/alternator windings 240 of a synchronous electric machine. At any instant, inverter 203 operates to commutate two of the phase windings 240 in series conduction, providing motoring torque or accepting generating current.

A controller 250 is operatively connected to switches 204, 205, 207, 208 of converter 202 and to inverter 203. Controller 250 corresponds functionally to controller 150 described above, with like sub-blocks performing the same operations. Controller 250 includes functional sub-blocks as: a PWM and dead-time generator 251, adaptive dead-time and valley detection logic 254, a current regulation loop 252 for motoring mode, a current regulation subject to battery voltage limits 253 for generating mode, a power-flow arbiter and hysteresis unit, and a battery-chemistry charging limits module. Controller 250 further receives feedback from current-sense element 222, DC-link voltage across capacitor 220, and battery voltage from 201.

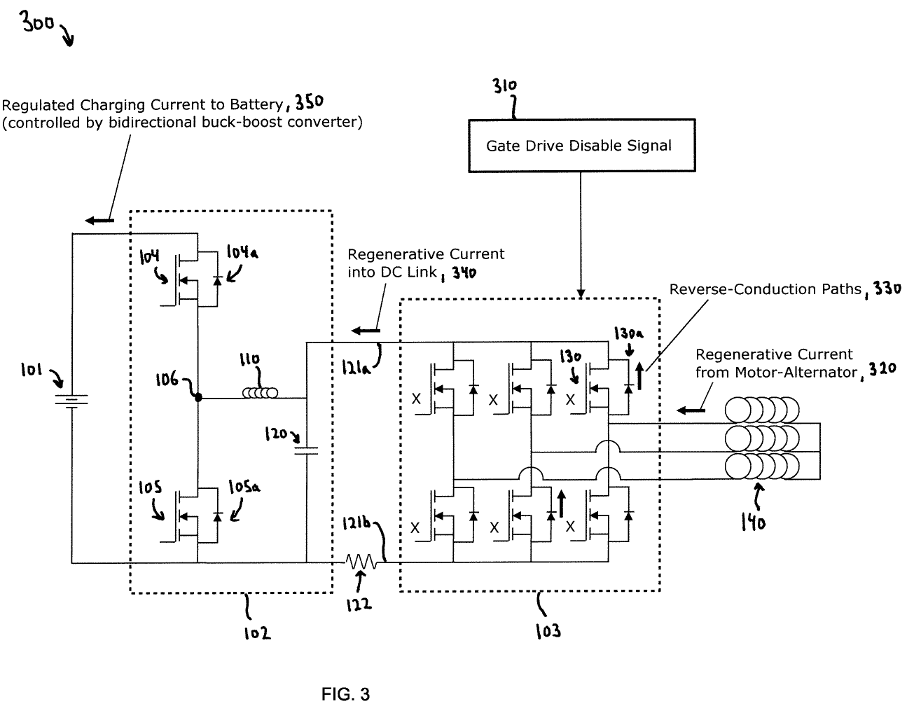

A schematic representation of an inverter-disabled regenerative-braking mode of a motor-alternator power conversion system of FIG. 1 in accordance with the invention is shown in FIG. 3. The inverter-disabled regenerative-braking mode illustrated in FIG. 3 is a fault-tolerant operating state of the same motor–alternator power conversion architecture described with respect to FIG. 1. All converter regulation, current control, dead-time management, and zero-voltage switching behavior described for normal motoring and generating operation remain applicable during this passive conduction state. The representation 300 comprises battery 101 that is coupled to a bidirectional ZVS buck-boost converter 102 that connects to commutation-inverter 103 and provides power to and from motor-alternator windings 140. Variable bus link 121a, 121b connects the converter 102 to the inverter 103 and current sensor 122 allow feedback for current control. Upon entering a passive conduction state (also referred to herein as an inverter-disabled regenerative-braking mode), gate drive disable signal 310 disables all gates of the transistors 130 in the inverter 103. Regenerative Current from the motor-alternator 320 flows from windings 140 to the inverter 103 and through the reverse-conduction paths or diodes 130a to the DC link 121a, 121b. Regenerative current in DC Link 340 flows to the bidirectional converter 102 regulates current while boosting voltage as needed to supply regulated charging current 350 back to the battery . Controller functionality including timing control, adaptive dead-time logic, power-flow arbitration, and mode sequencing may be implemented in hardware, firmware, software, or combinations thereof.

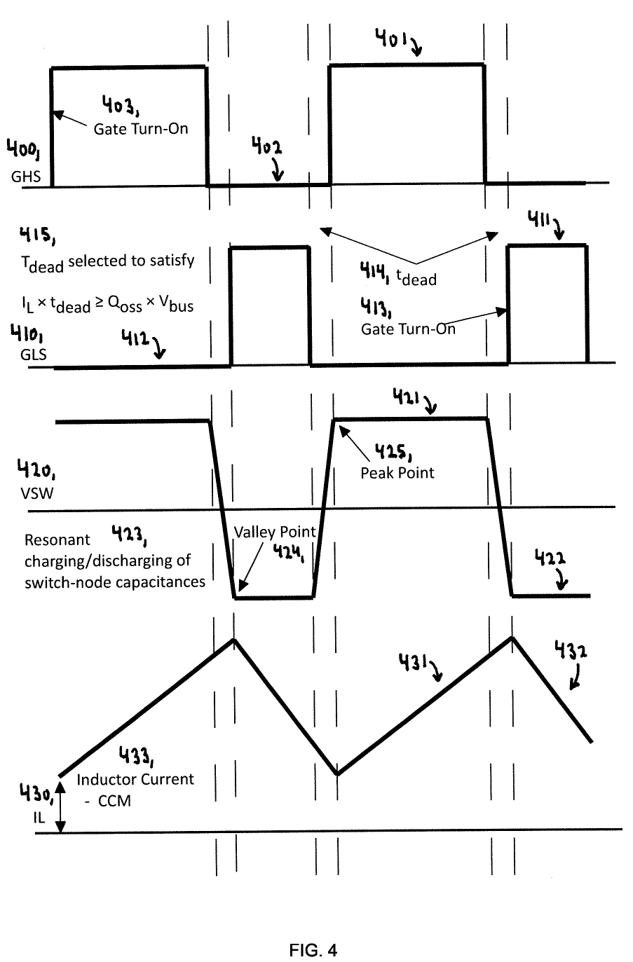

FIG. 4 illustrates representative timing waveforms of the bidirectional half-bridge buck-boost converter 102, including a high-side gate signal 400 (GHS), a low-side gate signal 410 (GLS), a switch-node voltage waveform 420 (VSW) at switch node 106, and an inductor current waveform 430 (IL) corresponding to current through inductor 110.

As shown, the high-side gate signal 400 includes a first gate turn-on event 403 followed by a turn-off event 402, and a subsequent on-interval 401. Similarly, the low-side gate signal 410 includes a turn-off event 412 and gate turn-on events 413 and 411. The controller 150 inserts a dead-time interval tdead 414 between turn-off of one device and turn-on of the complementary device. In the illustrated embodiment, dead-time selection 415 is made to satisfy the relationship I_{L} x t_{dead} ≥ Qₒₛₛ x V_{bus}, for at least a majority of switching cycles, as described elsewhere herein.

During dead-time 414, the inductor current 430 continues to flow through reverse-conduction paths of the half-bridge switches 104, 105, thereby resonantly charging and discharging switch-node capacitances and slewing the switch-node voltage waveform 420. The resonant charging/discharging interval is indicated at 423. As the switch node slews, the switch-node voltage waveform 420 reaches a valley point 424 and, in other portions of the cycle, reaches a peak point 425. The waveform segment 421 depicts the high level of VSW during a corresponding interval, and waveform segment 422 depicts the low level of VSW after the resonant transition.

Inductor current 430 remains substantially continuous, consistent with continuous-conduction operation. The current ripple is shown by rising and falling segments 431 and 432, and the inductor-current amplitude or magnitude reference is indicated at 433. In operation, when the inductor current magnitude decreases, such as during light-load conditions or near a motoring-to-generating boundary, the controller 150 may selectively adjust dead-time 414 and/or perform valley or near-valley turn-on aligned to valley point 424, thereby maintaining near-zero-voltage turn-on of the switches without auxiliary resonant networks, clamp circuits, or snubbers.

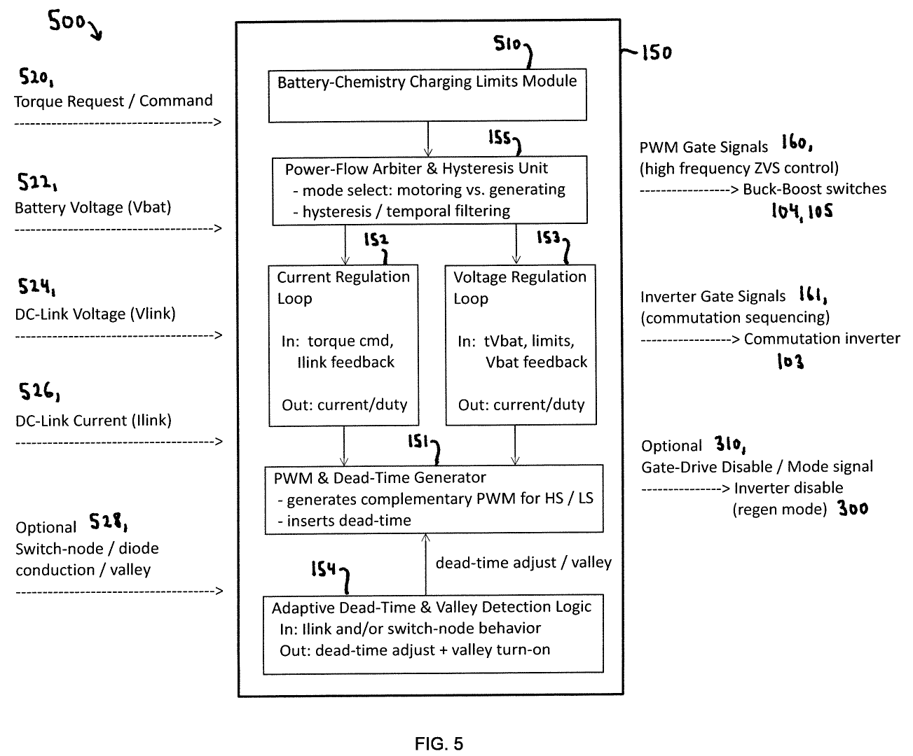

FIG. 5 illustrates a functional block diagram of controller 150. The controller receives a torque request/command 520, battery voltage feedback 521 (Vbat), DC-link voltage feedback 514 (Vlink), and DC-link current feedback 516 (Ilink). Optional feedback 523 may be provided indicative of switch-node behavior, diode conduction, or valley timing.

In the illustrated embodiment, a current regulation loop 152 regulates DC-link current in motoring operation, and a current regulation subject to battery voltage limits 153 regulates battery voltage in generating operation. A power-flow arbiter and hysteresis unit 155 selects an operating mode based on one or more indicators and applies hysteresis and/or temporal filtering to reduce mode chatter near zero-torque or zero-power boundaries.

A PWM and dead-time generator 151 produces gate-drive timing, including complementary PWM and dead-time insertion. Adaptive dead-time and valley detection logic 154 adjusts dead-time and/or switching instants based on feedback such as switch-node slope, diode-conduction intervals, or resonant valley timing, thereby preserving ZVS across varying operating conditions. The controller enforces battery-chemistry charging limits through a battery-chemistry charging limits module 510.

Controller outputs include high-frequency PWM gate signals 160 for the bidirectional half-bridge converter 102, and inverter gate signals 170 for commutation sequencing of the commutation inverter 103. An optional gate-drive disable or mode signal 310 may be generated for inverter-disabled regenerative operation, as described with respect to other figures herein.

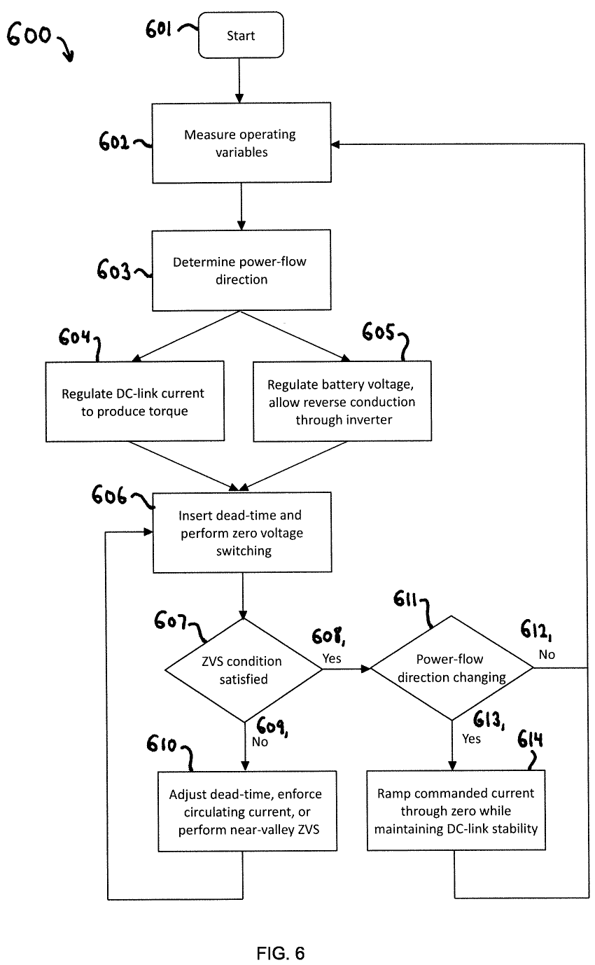

FIG. 6 illustrates a method 600 of operating the motor-alternator power conversion system. The method begins at start 601 and proceeds to measure operating variables at 602, which may include battery voltage, DC-link voltage, DC-link current, torque request, and switch-node or inverter conduction behavior. The controller then determines power-flow direction at 603.

If motoring operation is selected, the method proceeds to regulate DC-link current to produce torque at 604. If generating operation is selected, the method proceeds to regulate battery voltage and allow reverse conduction through the inverter at 605. Thereafter, the method inserts dead-time and performs zero-voltage switching at 606.

At decision 607, the controller evaluates whether the ZVS condition is satisfied. If “Yes” 608, the method proceeds to decision 611 to determine whether power-flow direction is changing. If “No” 612, the method returns to measuring operating variables at 602 and repeats.

If the ZVS condition is “No” 609, the method proceeds to step 610, where the controller adjusts dead-time, enforces circulating current, or performs near-valley ZVS to restore soft switching, after which the method returns to step 606 and re-evaluates ZVS at 607.

If power-flow direction is changing at decision 611, and the result is “Yes” 613, the controller ramps commanded current through zero while maintaining DC-link stability at steps 614. The method then returns to measuring operating variables at 602 for continued operation.

Obviously, numerous modifications and variations of the described preferred embodiment are possible and will occur to those skilled in the art in light of this disclosure of the invention. Accordingly, I intend that these modifications and variations, and the equivalents thereof, be included within the spirit and scope of the invention as defined in the following claims, wherein I claim:

1. A motor–alternator power conversion system comprising:
a battery;
a commutation output inverter coupled to phase windings of a synchronous electric machine, each inverter switch providing a reverse conduction path, said reverse conduction path comprising either an anti-parallel diode or channel conduction of a wide-bandgap transistor;
a non-isolated, bidirectional half-bridge buck-boost converter interposed between said battery and a DC link supplying said output inverter, said converter including a high-side switch, a low-side switch, an inductor, and a link capacitor; and a controller configured to:
(i) in a motoring mode, regulate current delivered by said half-bridge to said DC link in accordance with a current command for motor torque, while said output inverter commutates power to said phase windings;
(ii) in a generating mode, regulate current through said bidirectional half-bridge buck-boost converter by commanding said half-bridge to draw regenerative power from said electric machine through conduction of said inverter switches of said output inverter, including via reverse conduction paths and/or actively gated channel conduction into said DC link and to said battery; and
(iii) operate said half-bridge with pulse-width modulation and dead-time insertion such that each of said high-side and said low-side switches turns on at or near zero voltage over an operating range including said motoring and said generating modes, by ensuring sufficient inductor current during said dead-time to resonantly charge and discharge switch-node capacitances.

2. The system as described in claim 1 wherein: said controller maintains soft-switching without auxiliary commutation networks by enforcing a condition in which IL x tdead ≥ Qoss x Vbus, wherein IL is current through said inductor during a dead-time interval inserted by said controller, tdead is a duration of said dead-time interval, Qoss is an output charge of said high-side and said low-side switches, and Vbus is a DC-link voltage of said system, for at least a majority of switching cycles within said operating range.

3. The system as described in claim 1 wherein: said controller includes adaptive dead-time control responsive to at least one of: detected body-diode conduction interval, switch-node slope, or sensed valley timing.

4. The system as described in claim 1 wherein: said controller enforces a minimum circulating current bias in at least one of said motoring or said generating modes to preserve resonant energy for zero-voltage transitions.

5. The system as described in claim 1 wherein: said controller performs valley or near-valley turn-on when said inductor current is below a threshold sufficient to maintain zero-voltage switching, to reduce turn-on loss at light load.

6. The system as described in claim 1 wherein: power-flow direction selection is determined from one or more of: sign of torque request, sign of measured mechanical power, sign of said DC-link power, comparison of back electromotive force to said DC-link voltage, or polarity or magnitude of current through said inverter switches of said output inverter.

7. The system as described in claim 1 wherein: said controller applies hysteresis and temporal filtering to said power-flow decision to avoid mode chatter across said motoring–generating boundary.

8. The system as described in claim 1 wherein: said output inverter is operated as a hard-switched, non-modulating commutator while torque is regulated by said half-bridge current in said motoring mode.

9. The system as described in claim 1 wherein:
said inductor and said link capacitor are sized to (a) limit ripple current into said electric machine and (b) provide sufficient dynamic response to track said sinusoidal back electromotive force such that phase currents supplied to said motor are substantially flat-topped.

10. The system as described in claim 1 wherein: said active switches comprise wide-bandgap transistors selected from GaN or SiC with output charge Qoss low enough to enable switching frequencies in the hundreds of kilohertz to megahertz with efficiency exceeding 98%.

11. The system as described in claim 1 wherein: said bidirectional half-bridge buck-boost converter comprises a plurality of parallel converter legs operated with interleaved switching phases to reduce DC-link ripple and improve soft-switching margins, while said commutation output inverter remains free of high-frequency pulse-width modulation.

12. The system as described in claim 1 wherein: in said generating mode, said controller optionally disables synchronous conduction of said output inverter such that said reverse conduction paths provide a passive rectification path into said DC link during regeneration.

13. The system as described in claim 1 wherein: said controller seamlessly transitions between said motoring and said generating by ramping said current command through zero while maintaining said DC-link stability and preserving soft-switching.

14. A method of operating a motor–alternator power conversion system including a battery, a commutation output inverter coupled to a synchronous electric machine, and a non-isolated, bidirectional half-bridge buck-boost converter between said battery and a DC link, the method comprising:
supplying motoring torque by current-regulating said half-bridge to said DC link while said output inverter commutates said phase windings;
receiving regenerative power by current-regulating said half-bridge to draw regenerative
power from said electric machine into said DC link and to said battery while current flows
through said inverter switches of said output inverter, including via reverse conduction
paths and/or actively gated channel conduction; and
commanding PWM of said half-bridge with said dead-time such that, during both said motoring and said generating, each switch turns on at or near zero voltage by utilizing said inductor current during said dead-time to resonantly transfer charge between said switch-node capacitances.

15. The method as described in claim 14 wherein: said dead-time is adapted responsive to observed switch-node behavior to satisfy IL x tdead ≥ Qoss x Vbus, wherein IL is current through said inductor during said dead-time, tdead is a duration of said dead-time, Qoss is an output charge of active switches of said half-bridge, and Vbus is a DC-link voltage.

16. The method as described in claim 14 wherein: a minimum inductor-current floor is enforced near light-load boundaries to preserve said zero-voltage transitions.

17. The method as described in claim 14 wherein: valley turn-on or variable-frequency operation is performed when said inductor current is insufficient for full zero-voltage transition.

18. The method as described in claim 14 wherein: said power-flow direction is determined from at least one of: torque request sign, mechanical power sign, said DC-link power sign, back emf relative to said DC-link voltage, or polarity of current through said output inverter, and hysteresis is applied to said determination.

19. The method as described in claim 14 wherein:
said battery-chemistry-specific charging constraints are executed including constant-current and/or constant-voltage limits and temperature-based derating.

20. A controller for a motor–alternator power conversion system, said system including: a battery, a synchronous electric machine, a commutation output inverter coupled to phase windings of said electric machine, and a non-isolated, bidirectional half-bridge buck-boost converter coupled between said battery and a DC link supplying said output inverter, said controller comprising: control circuitry configured to generate pulse-width-modulated gate signals for said bidirectional half-bridge buck-boost converter; wherein said control circuitry is further configured to:
(i) generate gate signals for said commutation output inverter to commutate said phase windings based on rotor position information, while operating said commutation output inverter without high-frequency pulse-width modulation such that said commutation output inverter does not regulate phase current magnitude;
(ii) regulate current flowing between said battery and said DC link by pulse-width modulation of said bidirectional half-bridge buck-boost converter, wherein a magnitude and direction of said regulated current determine motor torque during motoring operation and regenerative braking torque during generating operation;
(iii) transition between motoring and generating operation by changing a sign of said regulated current through said bidirectional half-bridge buck-boost converter while maintaining substantially unchanged commutation timing of said commutation output inverter; and (iv) reverse rotational direction of said electric machine by reversing a commutation sequence applied to said commutation output inverter while controlling said regulated current through said bidirectional half-bridge buck-boost converter to maintain controlled torque during said reversal.

21. The controller as described in claim 20, wherein:
said control circuitry adapts dead-time applied to switching of said bidirectional half-bridge buck- boost converter based on at least one of switch-node slope, observed diode or channel conduction interval, or resonant valley timing, to maintain zero-voltage switching over variations in operating current.

22. The controller as described in claim 20, wherein: said control circuitry enforces a minimum circulating current through said bidirectional half-bridge buck-boost converter during light-load operation to preserve sufficient resonant energy for zero-voltage switching without inducing torque in said synchronous electric machine.

23. The controller as described in claim 20, wherein: said control circuitry determines a power-flow direction based on at least one of a commanded torque sign, a measured DC-link power sign, or a polarity of regulated current through said bidirectional half-bridge buck-boost converter, and applies hysteresis to prevent mode chatter across a motoring–generating boundary.

24. The controller as described in claim 20, wherein: said commutation output inverter is operated without high-frequency pulse-width modulation during both motoring and generating operation, thereby reducing common-mode voltage excursions and suppressing bearing currents in said synchronous electric machine.

25. The controller as described in claim 20, wherein: said control circuitry applies commutation overlap between phase conduction intervals of said commutation output inverter to reduce current discontinuities associated with commutation events.

26. The controller as described in claim 20, wherein:
said control circuitry limits a rate of change of regulated current commanded through said bidirectional half-bridge buck-boost converter during transitions between motoring and generating operation to reduce mechanical excitation and electrical stress.

27. A motor-alternator power conversion system comprising: a battery; a synchronous electric machine; a commutation output inverter coupled to phase windings of said synchronous electric machine, each inverter switch providing a reverse conduction path; a non-isolated, bidirectional half-bridge buck-boost converter coupled between said battery and a DC link supplying said commutation output inverter; and a controller configured to:
(i) detect a loss, disablement, or fault condition associated with gate-drive control of said commutation output inverter;
(ii) in response to said loss, disablement, or fault condition, maintain said commutation output inverter in a passive conduction state in which current is permitted to flow through said inverter switches via said reverse conduction paths;
(iii) during said passive conduction state, actively regulate current through said bidirectional half-bridge buck-boost converter to control regenerative braking torque applied by said synchronous electric machine; and (iv) thereby maintain controlled regenerative braking of said synchronous electric machine without requiring active gate control of said commutation output inverter.

28. The system as described in claim 27, wherein: during said passive conduction state said controller operates said bidirectional half-bridge buck-boost converter to transfer regenerative current to said battery when a DC-link voltage is less than a battery voltage.

29. The system as described in claim 27, wherein:
controlled regenerative braking is maintained over a speed range extending below a speed at which passive rectification through said inverter switches alone would cease to deliver power to said battery.

30. The system as described in claim 27, wherein: regenerative braking torque during said passive conduction state is determined primarily by a regulated converter current rather than by a rectified machine voltage.

31. The system as described in claim 27, wherein: during said passive conduction state said controller regulates converter current as a function of available DC-link energy to avoid DC-link overvoltage while maintaining regenerative braking torque.

32. The system as described in claim 27, wherein: said loss, disablement, or fault condition comprises at least one of a gate-driver fault indication, loss of gate-drive supply voltage, or a commanded torque-inhibit condition.
